(19) United States
(12) Patent Application Publication
(10) Pub. No.: US 2012/0112967 A1
(43) Pub. Date: May 10, 2012

(54) DUAL FIN ANTENNA

(76) Inventors: Jean-Philippe Coupez, Le Relecq Kerhuon (FR); Zied Charaabi, Tunis (TN); Jérémie Hemery, Tourch (FR); Christian Person, Saint Renan (FR)

(21) Appl. No.: 13/256,932

(22) PCT Filed: Mar. 16, 2010
(86) PCT No.: PCT/EP2010/053398

§ 371 Date: Jan. 19, 2012

(30) Foreign Application Priority Data
Mar. 17, 2009 (FR) 0951677

(51) Int. Cl. H01Q 9/04

(52) U.S. Cl. 343/700 MS

(57) ABSTRACT

The invention relates to a broadband antenna, including: a floorplan (P_{M}); at least one assembly including: a layer (P) of a dielectric material arranged perpendicularly to the floorplan (P_{M}), the layer having a given thickness; a first metal member (11) arranged on a surface of the layer (P); a second metal member (12) arranged on a surface of the layer (P) opposite the surface receiving the first metal member such that the metal members are not opposite each other; a power line combined with one of the two metal members, the power line extending from the edge of the metal member closest to a central axis of symmetry (Δ) of the antenna towards the floorplan (P_{M}).

### GENERAL TECHNICAL FIELD

The present invention relates to wide-band antennas and more particularly to those which may be mounted on base stations of a wireless communications network.

### STATE OF THE ART

The antenna is an indispensable element of a wireless communications network.

Particularly performing antenna solutions are therefore sought, notably in terms of bandwidth and of radiation purity, and having low manufacturing complexity.

Solutions of antennas of the dipole type mounted facing a ground plane playing the role of a reflector at a distance equal to a quarter of the wavelength are conventionally known.

These dipoles with a total length equal to half a wave length typically consist of two collinear strands and are energized via a balun. Both strands are positioned parallel to the reflecting plane.

However, present antennas do not have many degrees of freedom as for their adjustments with which good performances may be obtained in the desired frequency bands, and are complex to make.

### PRESENTATION OF THE INVENTION

The present invention proposes a wide-band antenna solution comprising several degrees of freedom as for its adjustments and it may be made in a simple way and at low cost.

According to a first aspect, the invention relates to a wide-band antenna comprising: a ground plane; at least one assembly comprising: a layer of dielectric material arranged perpendicularly to the ground plane, the layer having a thickness; a first metal element arranged on one face of the layer; a second metal element arranged on a face of the layer opposite to the face where the first metal element is arranged so that the metal elements are not facing each other; a power line associated with one of the two metal elements, the power line extending from the edge of the metal element which is the closest to a central axis of symmetry of the antenna, towards the ground plane.

The antenna may further have the following characteristics:
it comprises a first assembly and a second assembly, the dielectric material layers associated with each assembly being perpendicular to each other;
the power supply line consists of a first section extending from the metal element parallel to the ground plane, of a second section connected to the first section and extending from the first section perpendicularly to the ground plane towards the ground plane;
the second section comprises a first area and a second area, the second area being of a width which is greater than the first area so as to ensure a capacitive function.
the power line is made in the same material as the metal element with which it is associated.
the metal elements have a geometry selected from the following group: a rectangular geometry or a geometry of the fin type, narrow at the base connected to the ground plane and flared at the end above the ground plane.
the dielectric material Layer is air or consists of a substrate.
the power lines are connected to an energizing probe forming a means for powering the antenna.

According to a second aspect, the invention relates to a base station comprising at least one wide-band antenna according to the first aspect of the invention.

### PRESENTATION OF THE FIGURES

Other features and advantages of the invention will further become apparent from the following description which is purely an illustration and not a limitation and should be read with reference to the appended drawings wherein:

FIG. 1 illustrates a first embodiment of an antenna according to the invention;

FIG. 2 illustrates a second embodiment of an antenna according to the invention;

FIG. 3 illustrates a third embodiment of an antenna according to the invention;

FIGS. 4a and 4b respectively illustrate the adaptation levels in a Cartesian coordinate system and on a Smith abacus for the antenna according to the second embodiment of the invention;

FIGS. 5a, 5b and 5c illustrate the diagrams with co-polarization (solid line) and with cross-polarization (dotted line) in the plane E at frequencies of 2 GHz, 2.5 GHz and 3 GHz for the antenna according to the second embodiment of the invention;

FIGS. 6a, 6b and 6c illustrate the diagrams with co-polarization (solid line)and with cross-polarization (dotted line) in the plane H at frequencies of 2 GHz, 2.5 GHz and 3 GHz for the antenna according to the second embodiment of the invention;

FIG. 7 illustrates the gain obtained in the 2 GHz-3 GHz band for the antenna according to the second embodiment of the invention;

FIGS. 8a and 8b respectively illustrate the adaptation levels in a Cartesian coordinate system and on a Smith abacus for the first of the two antennas nested according to the third embodiment of the invention;

FIGS. 9a, 9b and 9c illustrate the diagrams with co-polarization (solid line) and with cross-polarization (dotted line) in the plane E at frequencies of 2 GHz, 2.5 GHz and 3 GHz for the first of the two antennas nested according to the third embodiment of the invention;

FIGS. 10a, 10b and 10c illustrate the diagrams with co-polarization (solid line) and with cross-polarization (dotted line)in the plane H at frequencies of 2 GHz, 2.5 GHz and 3 GHz for the first of the two antennas nested according to the third embodiment of the invention;

FIG. 11 illustrates the gain of the first of the two antennas nested according to the third embodiment of the invention;

FIGS. 12a and 12b respectively illustrate the adaptation levels in a Cartesian coordinate system and on a Smith abacus for the second of the two antennas nested according to the third embodiment of the invention;

FIGS. 13a, 13b and 13c illustrate the diagrams with co-polarization (solid line) and with cross-polarization (dotted line) in the plane E at frequencies of 2 GHz, 2.5 GHz and 3 GHz for the second of both antennas nested according to the third embodiment of the invention;

FIGS. 14a, 14h and 14c illustrate the diagrams with co-polarization (solid line) and with cross-polarization (dotted line) in the plane H at frequencies of 2 GHz, 2.5 GHz and 3 GHz for the second of the two antennas nested according to the third embodiment of the invention;

FIG. 15 illustrates the gain of the second of the two antennas nested according to the third embodiment of the invention;

FIG. 16 illustrates the isolation level between both antennas nested according to the third embodiment of the invention.

### DETAILED DESCRIPTION OF THE INVENTION

Structure of the Antenna

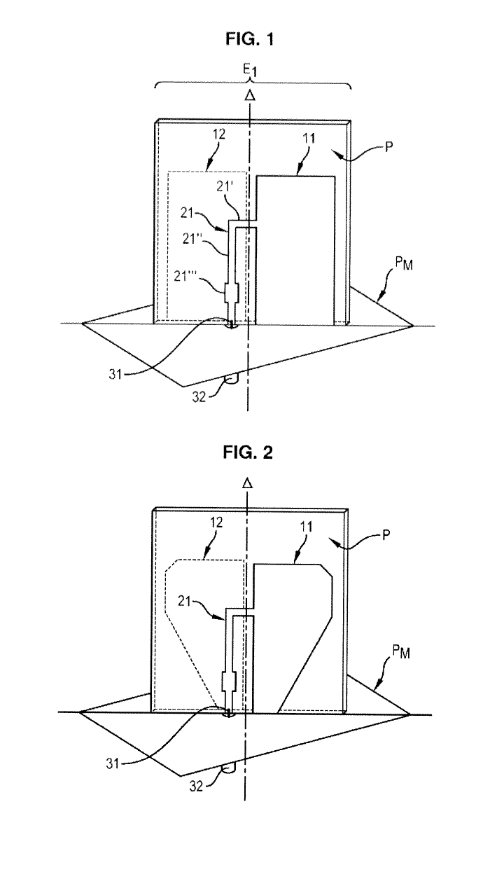

FIG. 1 illustrates a wide-band antenna comprising a ground plane P_{M} and at least two metal elements 11, 12 connected to the ground plane P_{M} at their base and extending perpendicularly to the ground plane.

The metal elements have a small thickness of the order of a few pm or tens of pm (for elements etched on a pre-metallized substrate) or even a few hundred of pm (for making the elements in a technology of the cut-out metal pattern type).

The antenna further comprises a power line 21. This power line is preferably a 50Ω microstrip line of a known type which uses one of the two metal elements as a reference ground plane for this line.

The antenna comprises a central axis Δ of symmetry.

The metal elements are apart and the space between them forms a central coupling slot (the slot is arranged at the central axis of symmetry of the antenna).

In this antenna, an assembly E1 formed with the metal elements and the power line is defined.

This assembly E1 notably comprises a layer of dielectric material arranged perpendicularly to the ground plane (P_{M}).

Each metal element is positioned on a face of the dielectric material layer. The metal elements are in particular positioned so that they are not facing each other.

The thickness of the dielectric layer is of the order of a few hundreds of μm to a few mm.

The power line is connected at its lower end to an energizing probe 31 which crosses the ground plane pierced for this purpose. The probe is preferably a 50Ω coaxial probe, the outer conductor 32 of which is connected to the ground plane.

The power line is formed by a first section 21′ extending from the metal element 11 with which it is associated parallel to the ground plane and a section 21″ connected to the first section extending from the first section 21′ perpendicularly towards the ground plane.

This power line further comprises on the second section 21″, an area 21′″ having a width greater than the width of the first 21′ and of the second 21″ section so as to ensure a capacitive adaptation effect. This area 21′″ is preferably positioned in proximity to the connection point with the 50Ω energizing probe.

The metal elements as well as the power line may be collectively printed on a dielectric substrate.

The substrate is of course perpendicular to the ground plane and plays the role of the dielectric material layer described up to here.

In this case, the assembly formed by the metal element 11 and the power line is printed on a face of the substrate so that the metal element 12 printed on the other face acts as a ground plane for the power line.

### First Embodiment

A first embodiment of the antenna is illustrated in FIG. 1 (described generally earlier).

In this embodiment, the metal elements 11, 12 are rectangular.

### Second Embodiment

A second embodiment of the antenna is illustrated in FIG. 2.

In this embodiment, the metal elements are flared from the ground plane.

The flaring is rectilinear and preferably perpendicular for the edge which is closest to the central axis Δ of symmetry of the antenna.

The metal elements are of a general trapezoidal shape and each form a fin.

Such metal elements have very many possibilities for the geometry.

Generally, these elements correspond to flared patterns with a convex surface from their base to their apex.

### Third Embodiment

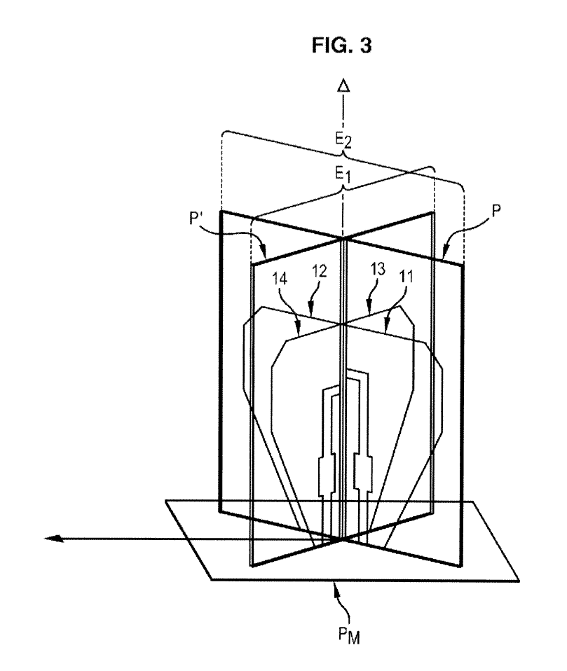

A third embodiment is illustrated in FIG. 3.

In this embodiment, the antenna comprises 4 metal elements and the antenna is of the bipolarization type.

It notably comprises a first assembly E1 and a second assembly E2 each formed by two metal elements and the associated power line.

The first assembly E1 corresponds to a first dielectric material layer P and the second assembly corresponds to a second dielectric material layer P′.

Both layers P, P′ of dielectric material are perpendicular to each other and the metal elements 11, 12, 13, 14 on each layer are identical.

The layers of dielectric material are in identical materials.

In other words, in this embodiment, the metal elements are nested perpendicularly at the central coupling slots without any contact between them.

This embodiment may be seen as the nesting of two antennas of the second embodiment described earlier.

The nested metal elements are identical and only the position of the connection point of the power line on the metal element coplanar with this line, as well as the position and the dimensions of the capacitive adaptation line area, differ.

The distinct heights associated with these connection points on the elements, allow both antennas to be combined without any electrical contact between them. With regard to the exterior circuits, each antenna remains energized at the lower end of the power line by an external 50Ω coaxial cable, for example. With this it is possible to operate this structure according to two perpendicularly crossed linear polarizations.

Performances

First Prototype

An antenna according to the second embodiment was made and characterized experimentally.

This antenna operates in a frequency band centered on 2.5 GHz.

Both metal elements as well as the 50Ω microstrip energizing line bearing the capacitive adaptation line section, are collectively printed on a dielectric substrate with a dielectric permittivity εᵣ=2.55 and with a thickness h=800 μm.

This substrate is positioned perpendicularly to the lower square-shaped ground plane, in which a drill hole was made so as to be able to mount the 50Ω coaxial cable ensuring the external power supply of the antenna.

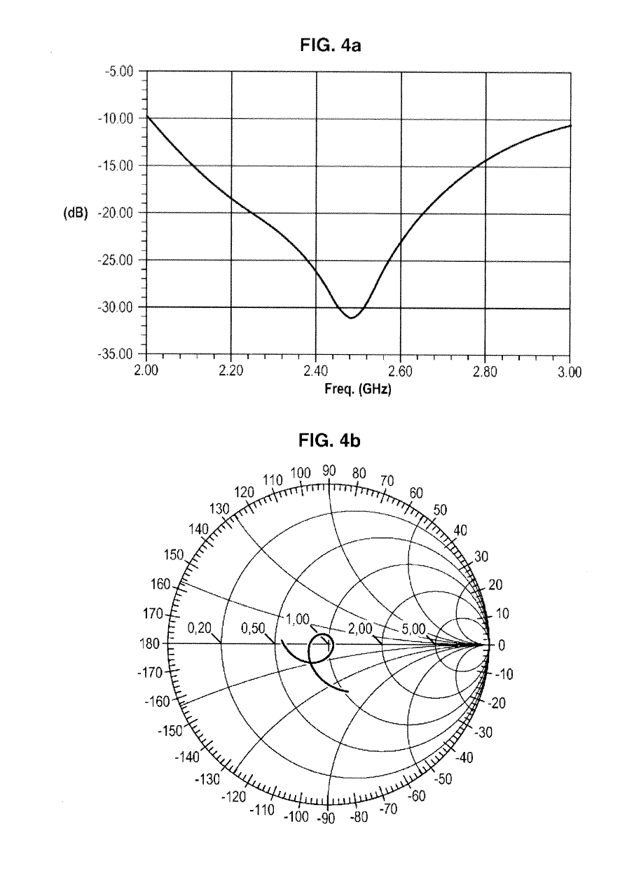

FIGS. 4a and 4b give the adaptation levels respectively in a Cartesian coordinate system and on a Smith abacus. It may be noted that this adaptation remains less than −10 dB over a wide band of frequencies, ranging from 2 GHz to more than 3 GHz, which corresponds to a relative bandwidth of more than 40%.

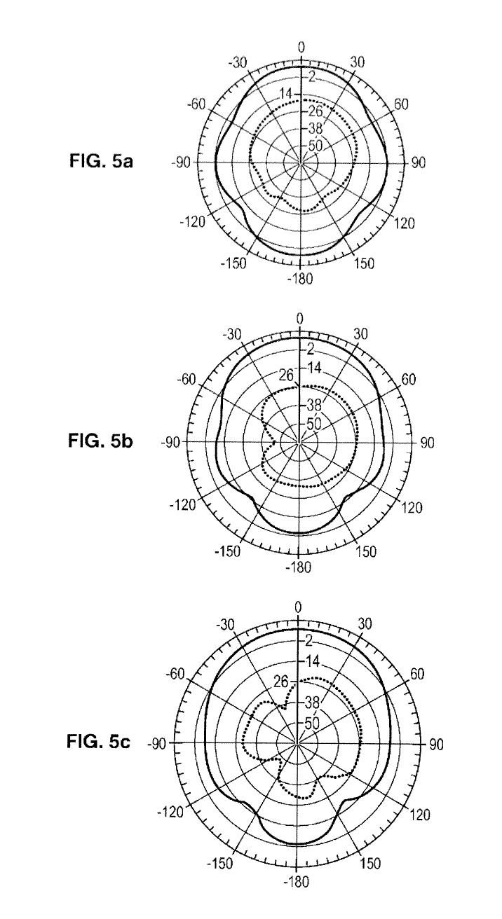

As regards the radiation characteristics, FIGS. 5a, 5b and 5c illustrate the diagrams with co-polarization (solid line) and with cross-polarization (dotted line) in the plane E (i.e. the plane comprising the substrate with the antenna and perpendicular to the ground plane), and this at frequencies of 2 GHz, 2.5 GHz and 3 GHz. On these different curves, good radiation performances versus frequency may be seen, with in particular a very low cross-polarization level in the main radiation axis of the antenna (i.e. in the direction θ=0°). Over the whole band from 2 GHz to 3 GHz, this cross-polarization level in the main axis remains less than that of co-polarization by more than 25 dB. This low cross-polarization value is moreover maintained over a relatively significant aperture angle in the plane E.

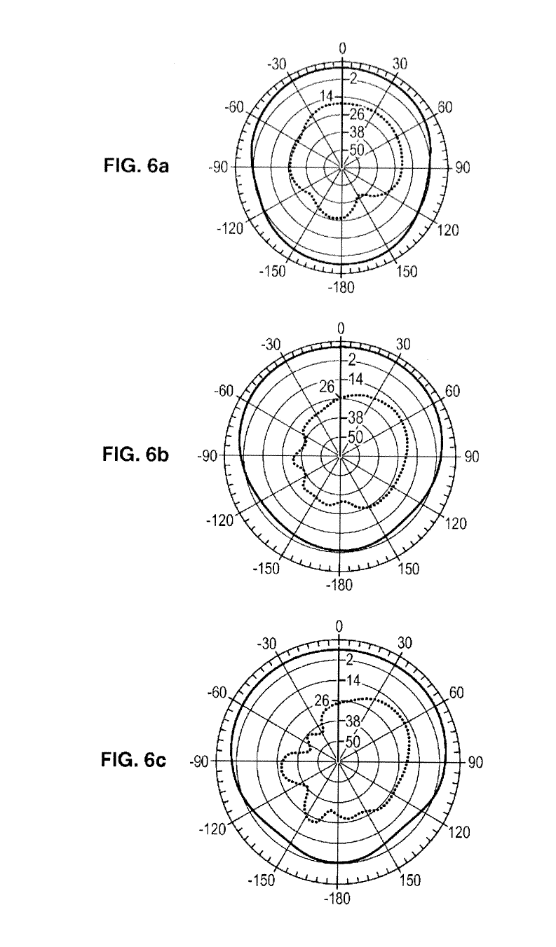

In the same way as for the previous figures, FIGS. 6a, 6b and 6c give radiation diagrams with co-polarization (solid line) and with cross-polarization (dotted line) in the plane H of the antenna (i.e. the plane perpendicular to the substrate of the antenna and to the ground plane). In this case, the conclusions on the cross-polarization levels are quite equivalent to the results obtained in the plane E.

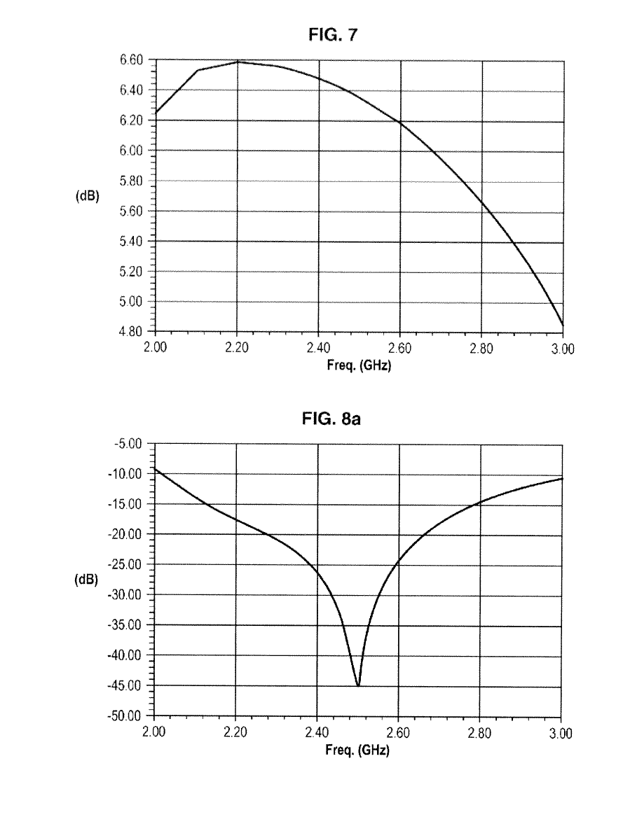

FIG. 7 illustrates the gain obtained in the 2 GHz-3 GHz band. This gain shows a maximum value of 6.6 dB at a frequency of 2.2 GHz.

Second Prototype

An exemplary solution of the bipolarization type, based on two perpendicularly crossed antennas, as this is shown in FIG. 3, was also made and experimentally characterized (see third embodiment).

For this structure, one of the two antennas, subsequently called “first antenna”, is strictly identical with the one described in the second embodiment. The other antenna, called a “second antenna”, is only distinguished from the previous one by a higher position of the connection point of the 50Ω microstrip line and by a slight modification of the capacitive adaptation line area.

In terms of distribution of the electric field, the same distribution is obtained for each of the two nested antennas as for each antenna taken separately.

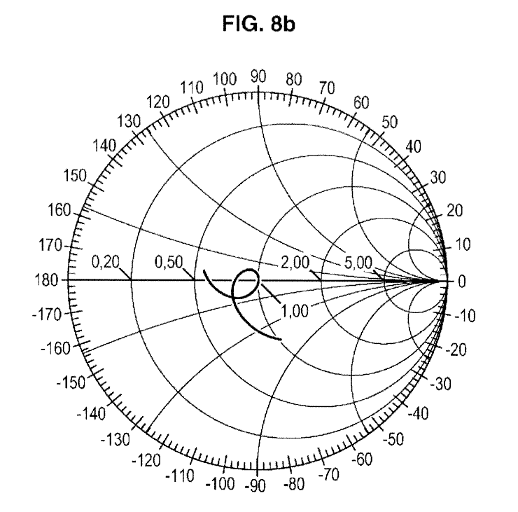

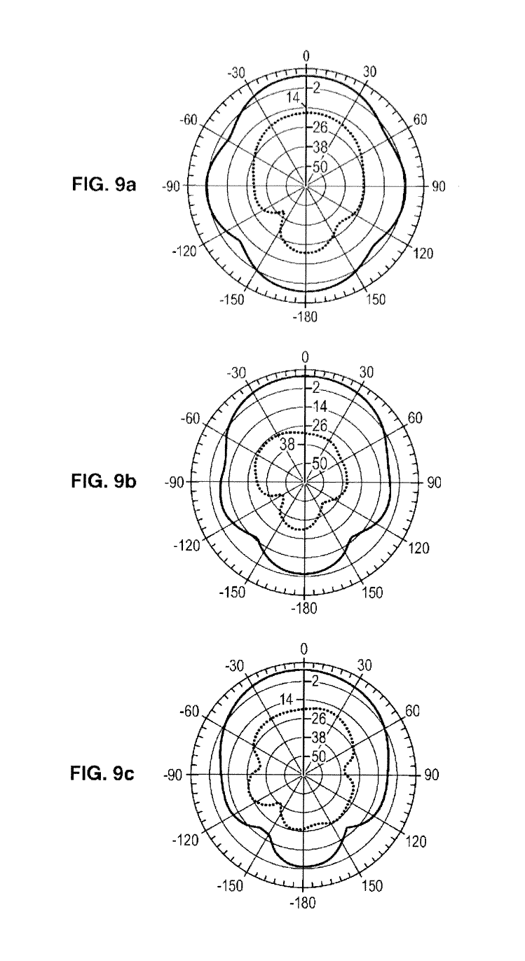

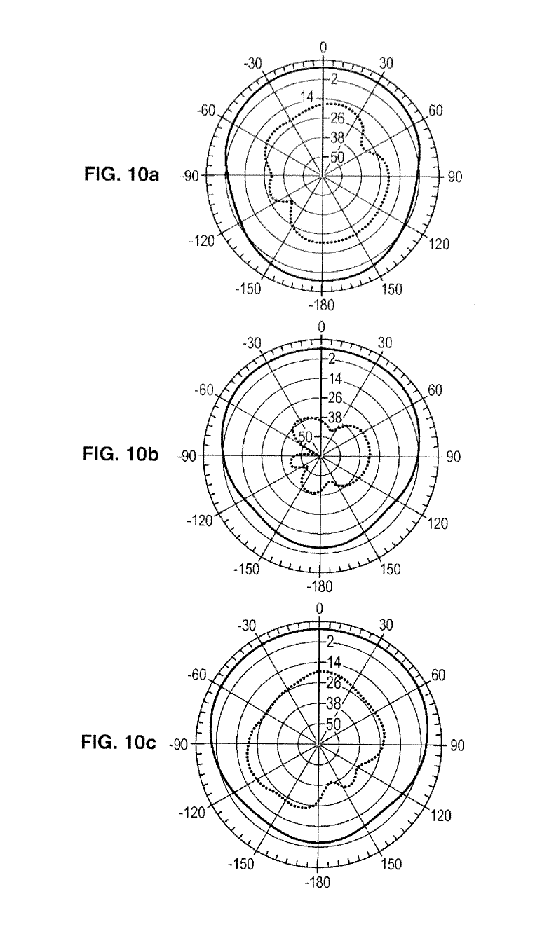

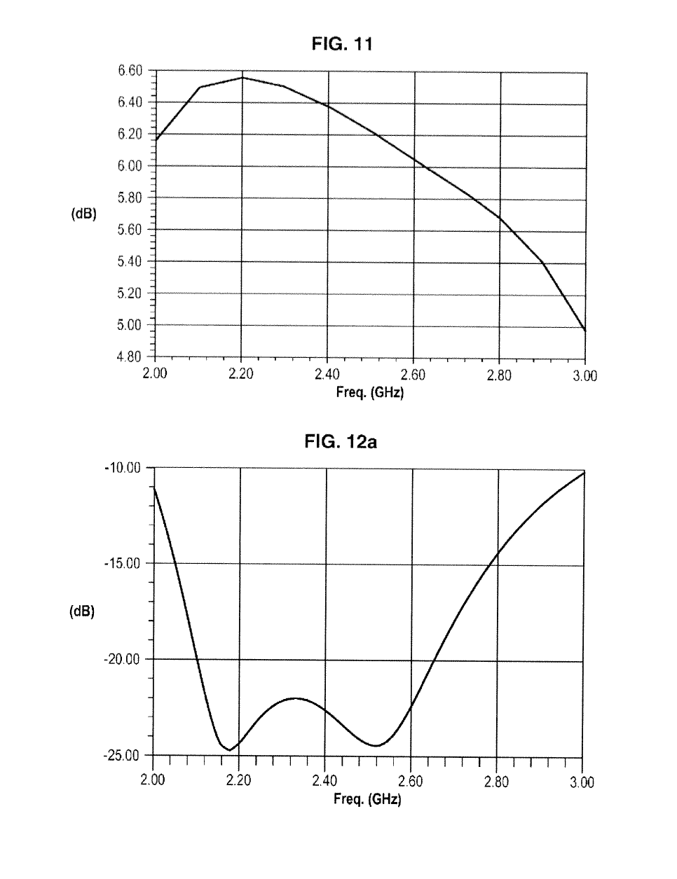

In the case when only the first antenna is energized, FIGS. 8-11 illustrate the adaptation in a Cartesian coordinate system (FIG. 8a) and on a Smith abacus (FIG. 8b), the radiation diagrams with co-polarization and cross-polarization in the plane E (FIGS. 9a, 9b, 9c) and in the plane H (FIGS. 10a, 10b, 10c) and the gain of the antenna (FIG. 11), respectively.

Like for the distribution of the electric field on the antenna, the performances are quite compliant with those obtained for a single antenna (see the performance of the first prototype).

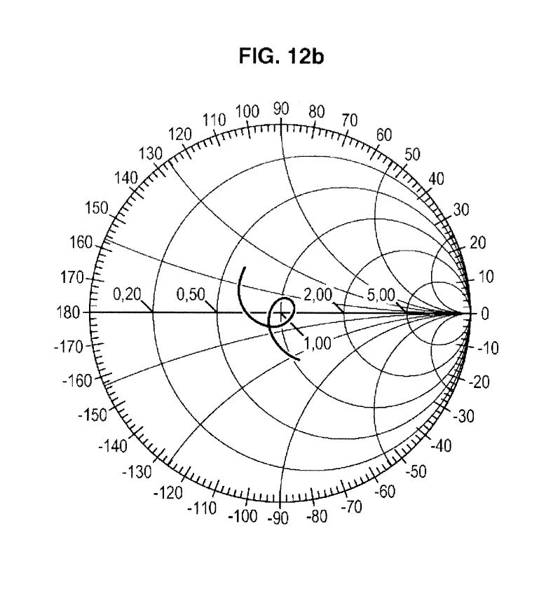

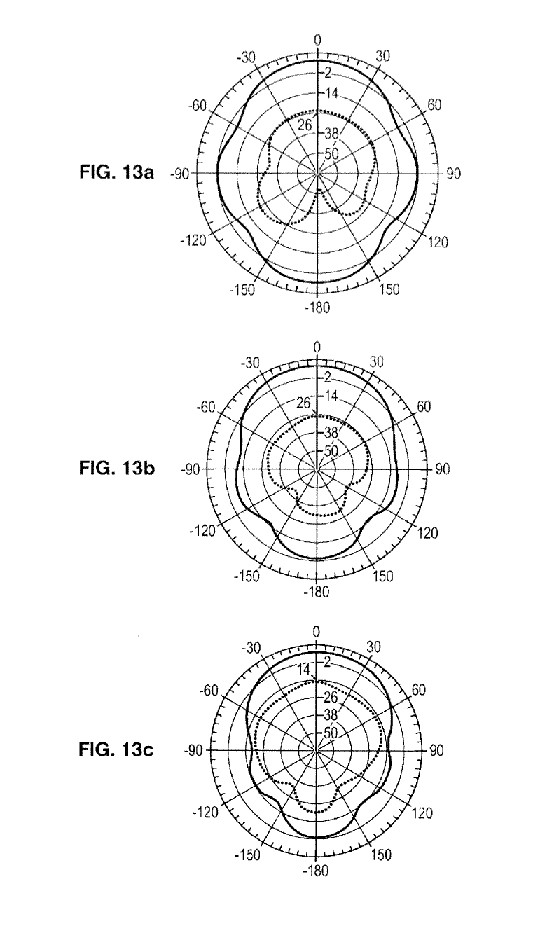

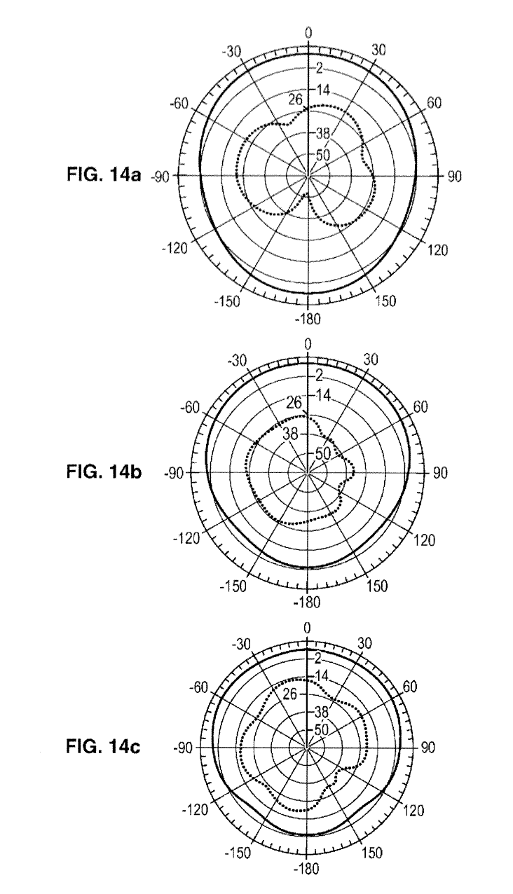

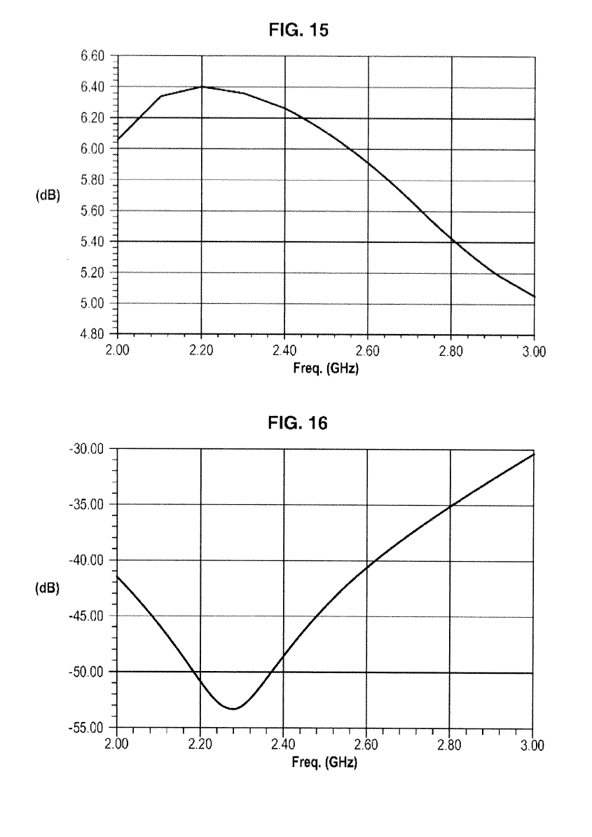

Similarly, in the case when only the second antenna is energized, FIGS. 12-15 respectively illustrate the adaptation in a Cartesian coordinate system (FIG. 12a) and on a Smith abacus (FIG. 12b), the radiation diagrams with co- and cross-polarization in the plane E (FIGS. 13a, 13b, 13c) and in the plane H (FIGS. 14a, 14b, 14c) and the gain of the antenna (FIG. 15), respectively.

Even if this second antenna slightly differs from the first, the obtained answers are always highly compliant with those illustrated in FIGS. 8-11. The conclusion of this is that the electric performances are therefore quite comparable whether either one of the polarizations is present.

FIG. 16 finally illustrates the coupling level between the first and the second antenna on the 2 GHz-3 GHz band.

As this may be seen, the isolation between both antennas remains excellent, since, on the whole of this frequency band, the coupling always remains less than −30 dB.

For this structure of the bipolarization type combining two antennas, the very strong isolation level between the latter is one of the major advantages of the proposed solution.

The antenna described above may also be used within the scope of a satellite link or be implemented in a base station of a communications network and it may be used on frequency bands comprised between 10 and 15 GHz.

1. A wide-band antenna comprising:
a ground plane (P_{M});
at least one assembly comprising:
a layer (P) of dielectric material arranged perpendicularly to the ground plane (P_{M}), the layer having a thickness;
a first metal element (11) arranged on one face of the layer (P);
a second metal element (12) arranged on one face of the layer (P) opposite to the layer where the first metal element is arranged so that the metal elements are not facing each other; the first and the second metal elements being with a convex surface;
a power line associated with one of the two metal elements, the power line extending from the edge of the metal element which is the closest to a central axis (Δ) of symmetry of the antenna, towards the ground plane (P_{M}).

2. The antenna according to claim 1 comprising a first assembly (E1) and a second assembly (E2), the layers between (P, P′) of dielectric material associated with each assembly being perpendicular to each other.

3. The antenna according to any of the preceding claims, wherein the power line consists of a first section extending from the metal element parallel to the ground plane, of a second section connected to the first section and extending from the first section perpendicularly to the ground plane towards the ground plane.

4. The antenna according to claim 3, wherein the second section comprises a first area and a second area, the second area being with a width greater than the first area so as to ensure a capacitive function.

5. The antenna according to one of the preceding claims, wherein the power line is made in the same material as the metal element with which it is associated.

6. The antenna according to one of the preceding claims, wherein the metal elements are of a geometry selected from the following group:
a rectangular geometry;
a geometry of the fin type, narrow at the base connected to the ground plane and flared at the end above the ground plane.

7. The antenna according to one of the preceding claims, wherein the dielectric material layer is air or consists of a substrate.

8. The antenna according to one of the preceding claims, wherein the power lines are connected to an energizing probe (31) forming a means for powering the antenna.

9. A base station of a wireless communications network comprising at least one antenna according to one of the preceding claims.
